(19) United States
(12) Patent Application Publication
(10) Pub. No.: US 2006/0181604 A1
(43) Pub. Date: Aug. 17, 2006

(54) Solid scanning optical writing device

(75) Inventors: Yuta Miyagawa, Hirakata-shi (JP); Shinji Harada, Sakai-shi (JP); Masaya Kinoshita, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/341,322

(22) Filed: Jan. 27, 2006

(30) Foreign Application Priority Data
Feb. 16, 2005 (JP) 2005-39735

(51) Int. Cl. B41J 2/47

(52) U.S. Cl. 347/255

(57) ABSTRACT

A plurality of optical shutter elements having an electro-optical effect is juxtaposed in a main scanning direction, and the light emitted from a light source comprising LED groups is modulated by turning on and off the optical shutter elements to thereby form an image on a photosensitive material. The optical shutter elements are turned on at a predetermined timing every scanning. The light source is turned on after a lapse of a predetermined time from the turning-on of the optical shutter elements.

This application is based on the application No. 2005-039735 filed in Japan, the contents of which are hereby incorporated by reference.

### BACKGROUND OF THE INVENTION

1. Field of the Invention

The present invention relates to a solid scanning optical writing device. More particularly, the present invention relates to a solid scanning optical writing device that draws an image on a photosensitive material such as photographic paper by modulating light emitted from the light source by an optical shutter module in which a plurality of optical shutter elements having an electro-optical effect are juxtaposed in a main scanning direction.

2. Description of the Related Art

As an optical writing device for forming an image on photographic paper using a sliver-halide photosensitive material or film, a solid scanning optical writing device has conventionally been proposed in which light emitting diodes (hereinafter, abbreviated as LEDs) whose on and off can be controlled are used as the light source, a plurality of optical modulation regions (optical shutter elements) are formed on optical shutter chips made of PLZT or LiNbO₃ which is a material having an electro-optical effect, the chips are arranged in an array in the main scanning direction, and the optical shutter elements is controlled. The solid scanning optical writing device is provided with individual electrodes and common electrodes for driving the optical shutter elements.

However, this type of optical writing device has a problem that when a gray image is drawn, because of the number of driving elements (optical shutter elements) in the main scanning direction, a density difference is caused in the image in spite of images of the same gradation being drawn.

This is attributed to the fact that when the optical shutter elements are turned on and off, current is caused at the optical shutter elements due to the charge and discharge of the optical shutter elements and the driving voltage applied to the optical shutter elements fluctuates transiently. Further, when the pixels (elements) to be driven are different, the transient voltage fluctuation is also caused. Consequently, a density difference in the image occurs.

Moreover, since a difference of the leakage light quantity according to the characteristic of each optical shutter element is also caused, in gray images, unevenness in streaks in units of pixels shows up.

Specifically, as shown in FIG. 13, in a time T assigned to each of the drawing colors of R, G and B, the LED serving as the light source is turned on at a start timing t1 and turned off at an end timing t2. The optical shutter elements No. 1 to No. K are turned on at a timing t3 slightly delayed from the start timing t1, and turned off at a timing t4 corresponding to a predetermined gradation. Here, the timing t4 is an average turning-off timing corresponding to the predetermined gradation. That is, in FIG. 13, although the elements No. 1 to No. K draw images of the same gradation, since the slight difference in transmitted light quantity characteristic among the elements is corrected, the turning-on (exposure) time slightly differs among the elements.

In the above-described control, as shown in the region a of FIG. 13, since the shutter elements are simultaneously turned on, the influence of the noise due to transient current is superimposed on the optical output waveform as shown in the region b of FIG. 13. Since the degree of superimposition of the noise differs according to the load of driving (the number of optical shutter elements), in the case of gray images of the same gradation, a density difference is caused in the image due to the difference in the width in the main scanning direction.

Moreover, since the leakage light characteristic differs among the optical shutter elements, unevenness in streaks shows up in units of pixels (elements) in the region c of FIG. 13.

As shown in the region d of FIG. 13, since the turning-on time is corrected for each element although the elements draw images of the same gradation, the timings at which the optical shutter elements are turned off differ from one another, so that the influence of the noise is so small that it can be ignored.

Accordingly, an object of the present invention is to provide a solid scanning optical writing device capable of preventing the occurrence of the density difference or the generation of unevenness in streaks when gray images of the same gradation are drawn.

### SUMMARY OF THE INVENTION

To attain the above-mentioned object, a solid scanning optical writing device comprising: an optical shutter module in which a plurality of optical shutter elements having an electro-optical effect are disposed in a main scanning direction; a light source that is capable of being controlled within a writing time assigned for drawing one pixel and emits light to the optical shutter elements; a first driver for driving each of the optical shutter elements according to image data; and a second driver for driving the light source, wherein the first driver turns on the optical shutter elements, and wherein the second driver turns on the light source after a lapse of a predetermined time from the turning-on of the optical shutter elements.

In the following description, like parts are designated by like reference numbers throughout the several drawings.

### BRIEF DESCRIPTION OF THE DRAWINGS

FIG. 1 is a perspective view showing an example of a solid scanning optical writing device according to the present invention;

FIG. 2 is a timing chart showing a control according to a first embodiment;

FIG. 3 is a timing chart showing a control according to a second embodiment;

FIG. 4 is a timing chart showing a control according to a third embodiment;

FIG. 5 is a timing chart showing a control according to a fourth embodiment;

FIG. 6 is a timing chart showing a control according to a fifth embodiment;

FIG. 7 is a timing chart showing a control according to a sixth embodiment;

FIG. 8 is a timing chart showing a control according to a seventh embodiment;

FIG. 9 is a timing chart showing a control according to an eighth embodiment;

FIG. 10 is a timing chart showing a control according to a ninth embodiment;

FIG. 11 is a timing chart showing a control according to a tenth embodiment;

FIG. 12 is a timing chart showing a control according to an eleventh embodiment; and

FIG. 13 is a timing chart showing the control according to the conventional art.

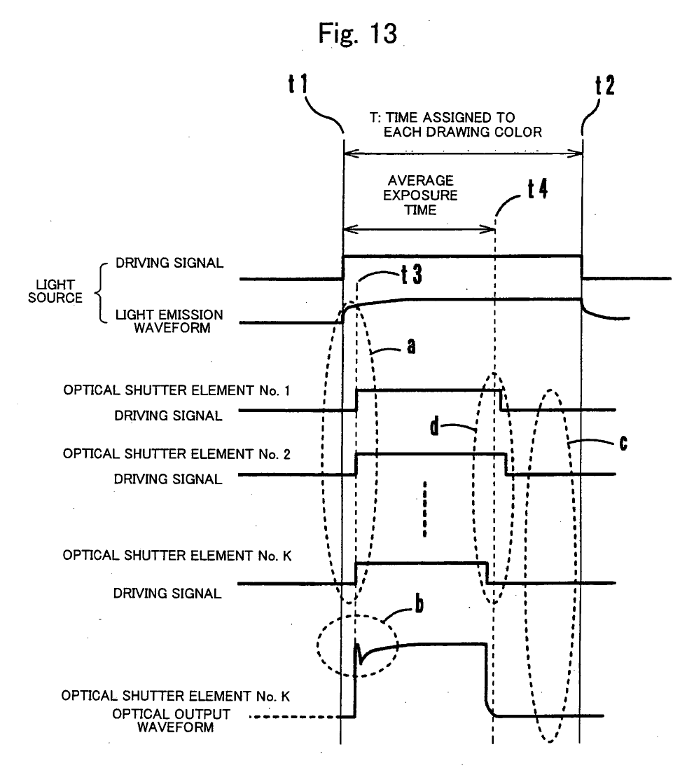

### DETAILED DESCRIPTION OF THE PREFERRED EMBODIMENTS

Hereinafter, embodiments of the solid scanning optical writing device will be described with reference to the attached drawings.

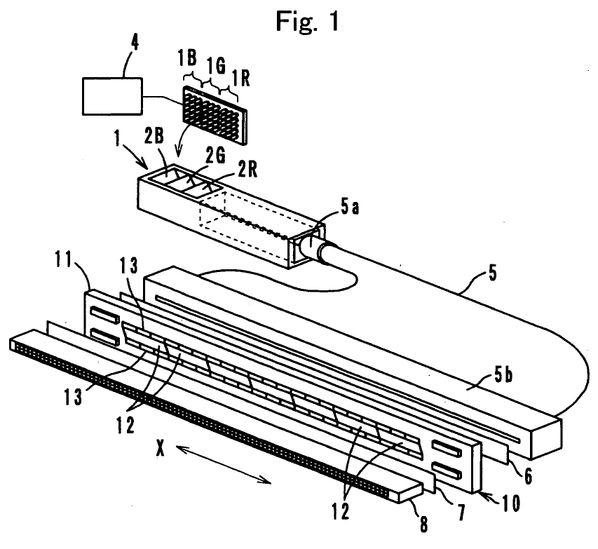

(Outline of the Structure of the Solid Scanning Optical Writing Device, see FIG. 1)

The solid scanning optical writing device shown in FIG. 1 is structured as a print head for forming an image on a recording medium such as photographic paper or a photosensitive film. The solid scanning optical writing device is provided with a light source unit 1, an optical fiber array 5, a polarizer 6, an optical shutter module 10, an analyzer 7, and an image forming lens array 8.

The light source unit 1 causes the light beams emitted from a plurality of LED groups 1R, 1G and 1B assigned to three colors of red (R), green (G) and blue (B) to be reflected or transmitted by dichroic mirrors 2R, 2G and 2B, respectively, and directs them to an incident end 5a of the optical fiber array 5. The on and off of the LED groups 1R, 1G and 1B is controlled by a driving circuit 4.

The optical fiber array 5, which comprises a bundle of a plurality of optical fibers, linearly emits the light incident from the incident end 5a, from an exit end 5b. The polarizer 6 and the analyzer 7 are arranged in crossed Nicol and situated so that the polarization planes thereof are at an angle of 45 degrees with respect to the electric field direction applied to the optical shutter elements.

In the optical shutter module 10, a plurality of optical shutter chips 12 made of PLZT are arranged in the main scanning direction X on a base 11 made of glass, and the optical shutter elements formed on the optical shutter chips 12 are driven by a driving IC 13. The basic method of driving the optical shutter elements having an electrooptic effect based on image data having a gradation and forming a color image on photographic paper by light beams of the three colors of R, G and B are known, and description thereof is therefore omitted.

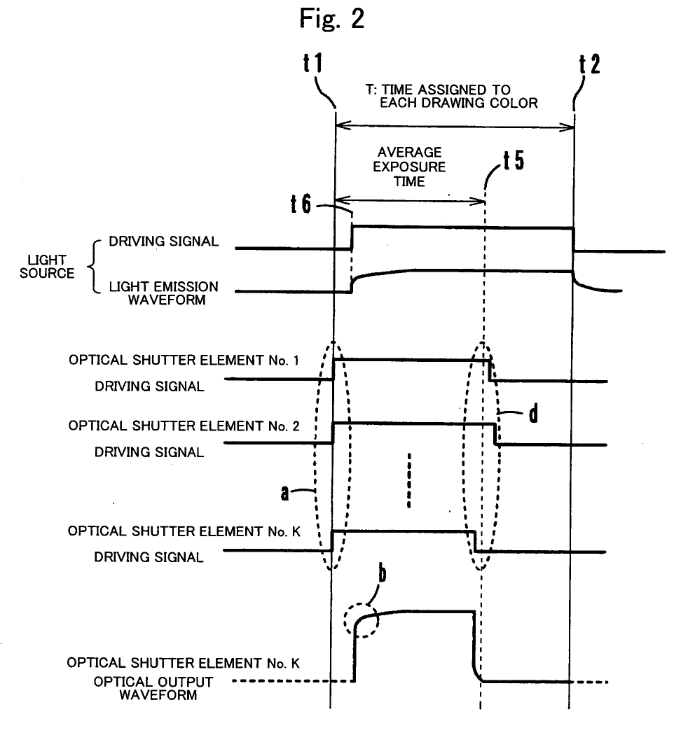

### First Embodiment, See FIG. 2

As shown in FIG. 2, every scanning, the driving IC 13 turns on the optical shutter elements No. 1 to No. K simultaneously with the start timing t1 of the time T assigned to each drawing color, and turns them off at a timing t5 corresponding to a predetermined gradation. Here, t5 is the average turning-off timing for the predetermined gradation. In FIG. 2, although the elements No. 1 to No. K draw images of the same gradation, since the slight difference in transmitted light quantity characteristic among the elements is corrected, the turning-on (exposure) time slightly differs among the elements.

On the other hand, every-scanning, the driving circuit 4 turns on the LED groups 1R, 1G and 1B at a timing t6 slightly delayed from the start timing t1, and turns them off at the end timing t2.

In the first embodiment, since the turning-on timing of the light source is delayed from the turning-on timing t1 of the optical shutter elements No. 1 to No. K, the light source is turned on after the transient characteristic of the common elements of the optical shutter elements is eased. Consequently, the noise due to the transient current when the optical shutter elements are turned on (the region a of FIG. 2) does not readily affect the optical output waveform when the light source is turned on (see the region b of FIG. 2). Thereby, the gradation characteristic in the optical output waveform at the optical shutter elements No. 1 to No. K does not readily break, so that the density difference caused when gray images of the same gradation are drawn is eliminated.

Moreover, as shown in the region d of FIG. 2, the timings at which the optical shutter elements No. 1 to No. K are turned off are different from one another because the turning-on timing is corrected for each element although they draw images of the same gradation. For this reason, the influence of the noise is so small that it can be ignored.

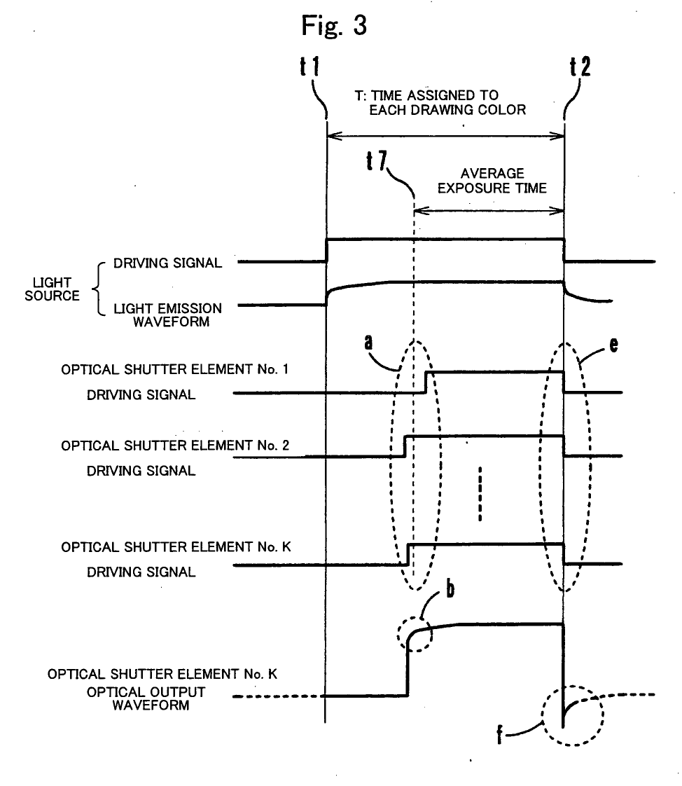

### Second Embodiment, See FIG. 3

As shown in FIG. 3, every scanning, the driving IC 13 simultaneously turns off the optical shutter elements No. 1 to No. K at the end timing t2 of the time T assigned to each drawing color. The timing at which the optical shutter elements No. 1 to No. K are turned on is a timing t7 when an exposure time (corrected for each element) corresponding to a predetermined gradation is secured. The timing t7 is the average exposure time.

On the other hand, every scanning, the driving circuit 4 turns on the LED groups 1R, 1G and 1B at the start timing t1 of the time T assigned to each drawing color, and turns them off at the end timing t2. That is, the light source is turned off synchronously with the turning-off of the optical shutter elements No. 1 to No. K.

In the second embodiment, since the optical shutter elements No. 1 to No. K are simultaneously turned off, the influence of the noise due to the transient current is exerted when the elements are off (the region e of FIG. 3). However, since the light source is turned off at the same time, the influence of the noise is small (see the region f of FIG. 3), and no influence is exerted on the image.

Moreover, the timings at which the optical shutter elements No. 1 to No. K are turned on are different from one another (see the region a of FIG. 3) because the turning-on timing is corrected for each element although they draw images of the same gradation. For this reason, the influence of the noise is so small that it can be ignored (the region b of FIG. 3).

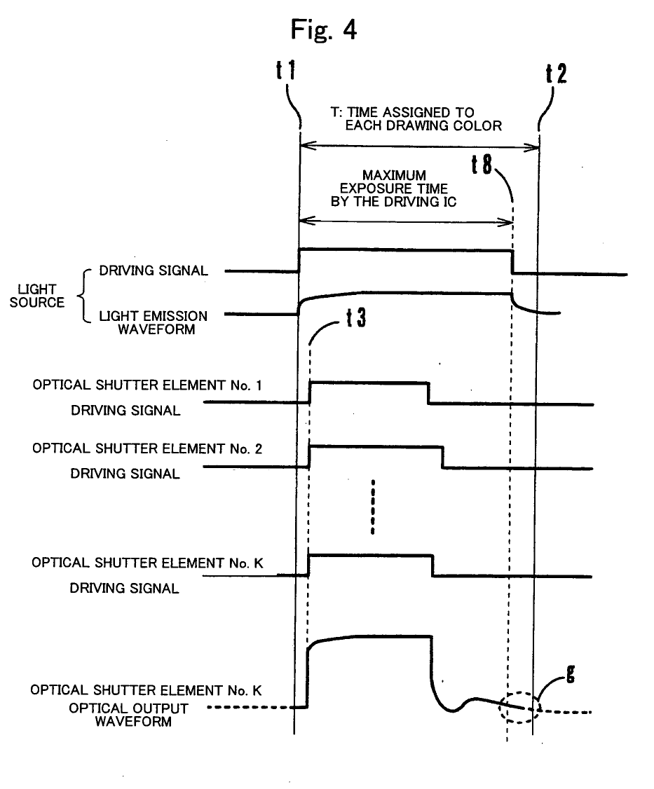

### Third Embodiment, See FIG. 4

As shown in FIG. 4, every scanning, the driving circuit 4 turns on the LED groups 1R, 1G and 1B at the start timing t1 of the time T assigned to each drawing color, and turns them off at a timing t8 when the maximum exposure time by the driving IC 31 ends.

On the other hand, every scanning, the driving IC 13 turns on the optical shutter elements No. 1 to No. K at the timing t3 slightly delayed from the start timing t1, and turns them off at a timing corresponding to a predetermined gradation.

In the third embodiment, since the light source is turned off at a comparatively short interval after the optical shutter elements No. 1 to No. K are turned off, the influence of the leakage light is eliminated. That is, as shown in the region g of FIG. 4, the breakage of the gradation characteristic due to the leakage light from the optical shutter elements No. 1 to No. K is reduced, so that the generation of the unevenness in streaks is eliminated.

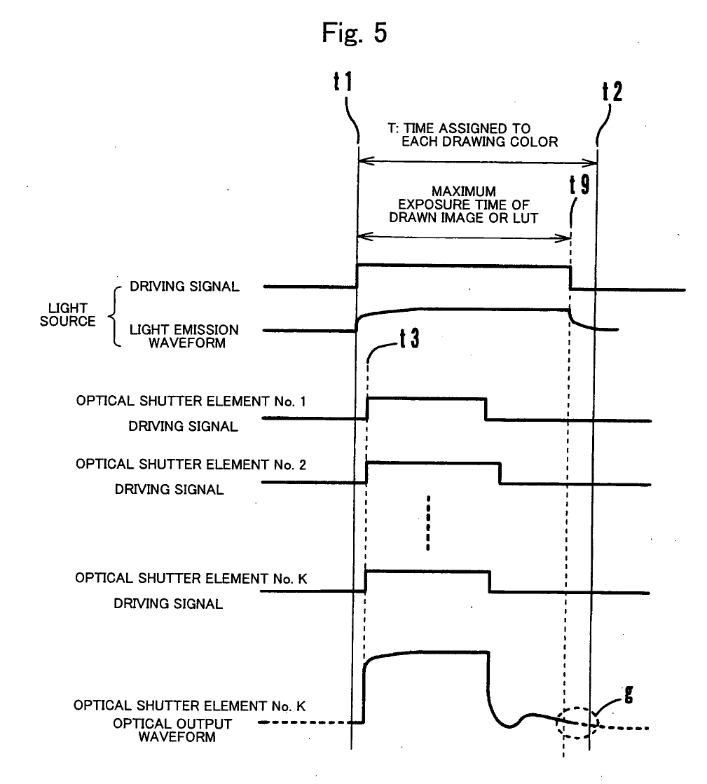

### Fourth Embodiment, See FIG. 5

As shown in FIG. 5, every scanning, the driving circuit 4 turns on the LED groups 1R, 1G and 1B at the start timing t1 of the time T assigned to each drawing color, and turns them off at a timing t9 when the exposure time corresponding to the maximum gradation included in the image data (that is, the maximum gradation of the drawn image or a look-up table (LUT) for gradation) ends.

On the other hand, every scanning, the driving IC 13 turns on the optical shutter elements No. 1 to No. K at the timing t3 slightly delayed from the start timing t1, and turns them off at a timing corresponding to a predetermined gradation.

In the fourth embodiment, like in the third embodiment, since the light source is turned off at a comparatively short interval after the optical shutter elements are turned off, the breakage of the gradation characteristic due to the leakage light from the optical shutter elements No. 1 to No. K is reduced, so that the generation of the unevenness in streaks is eliminated (see the region g of FIG. 5).

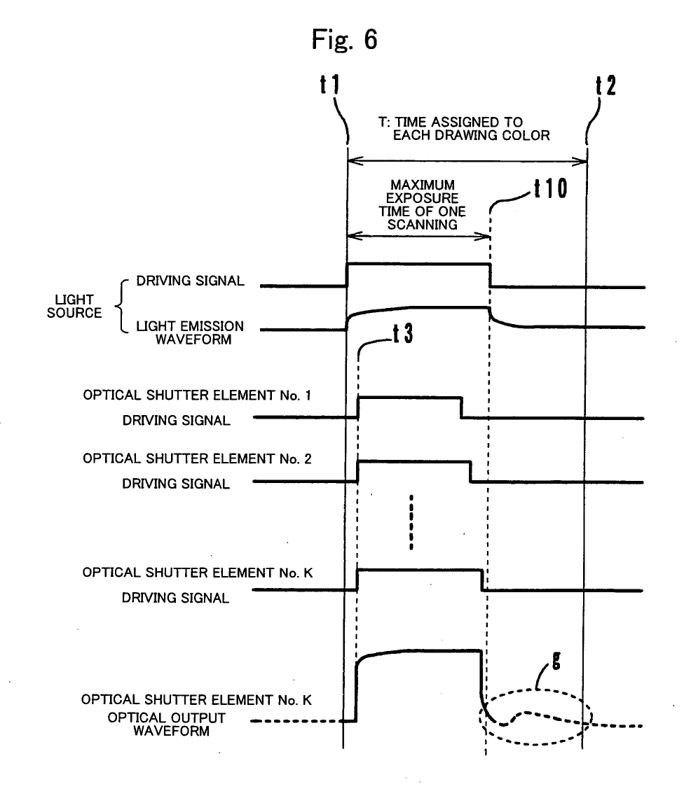

### Fifth Embodiment, See FIG. 6

As shown in FIG. 6, every scanning, the driving circuit 4 turns on the LED groups 1R, 1G and 1B at the start timing t1 of the time T assigned to each drawing color, and turns them off at a timing t10 when the maximum exposure time of one scanning line (that is, the exposure time corresponding to the maximum gradation included in the image data of one scanning) ends.

On the other hand, every scanning, the driving IC 13 turns on the optical shutter elements No. 1 to No. K at the timing t3 slightly delayed from the start timing t1, and turns them off at a timing corresponding to a predetermined gradation.

In the fifth embodiment, like in the third and the fourth embodiments, since the light source is turned off at a comparatively short interval after the optical shutter elements are turned off, the breakage of the gradation characteristic due to the leakage light from the optical shutter elements No. 1 to No. K is reduced, so that the generation of the unevenness in streaks is eliminated (see the region g of FIG. 6).

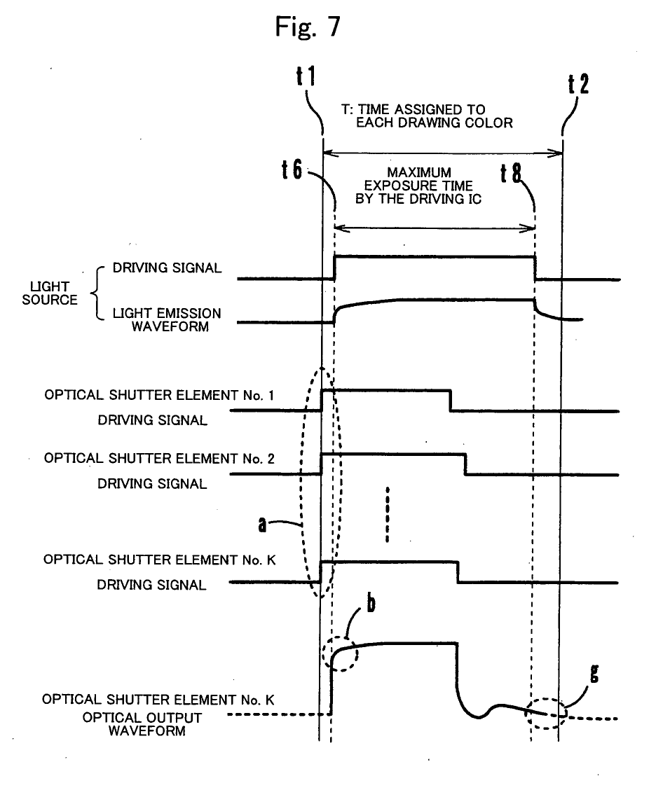

### Sixth Embodiment, See FIG. 7

As shown in FIG. 7, every scanning, the driving IC 13 turns on the optical shutter elements No. 1 to No. K simultaneously with the start timing t1 of the time T assigned to each drawing color, and turns them off at a timing corresponding to a predetermined gradation.

On the other hand, every scanning, the driving circuit 4 turns on the LED groups 1R, 1G and 1B at the timing t6 slightly delayed from the start timing t1, and turns them off at the timing t8 when the maximum exposure time by the driving IC 31 ends.

In the sixth embodiment which is a combination of the first and the third embodiments, like in the first embodiment, the density difference caused when gray images of the same gradation are drawn is eliminated (see the region b of FIG. 7), and like in the third embodiment, the generation of the unevenness in streaks is eliminated (see the region g of FIG. 7).

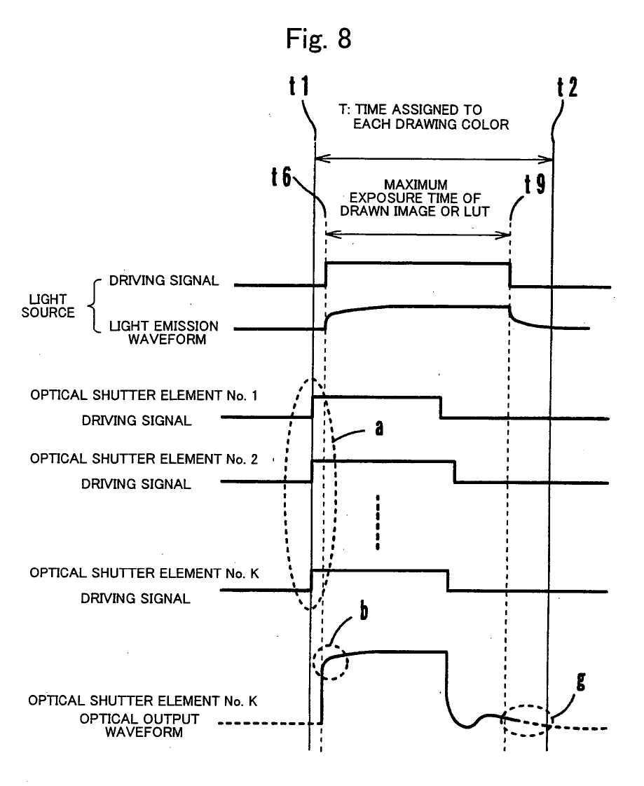

### Seventh Embodiment, See FIG. 8

As shown in FIG. 8, every scanning, the driving IC 13 turns on the optical shutter elements No. 1 to No. K simultaneously with the start timing t1 of the time T assigned to each drawing color, and turns them off at a timing corresponding to a predetermined gradation.

On the other hand, every scanning, the driving circuit 4 turns on the LED groups 1R, 1G and 1B at the timing t6 slightly delayed from the start timing t1, and turns them off at the timing t9 when the exposure time corresponding to the maximum gradation included in the image data (that is, the maximum gradation of the drawn image or a look-up table (LUT) for gradation) ends.

In the seventh embodiment which is a combination of the first and the fourth embodiments, like in the first embodiment, the density difference caused when gray images of the same gradation are drawn is eliminated (see the region b of FIG. 8), and like in the fourth embodiment, the generation of the unevenness in streaks is eliminated (see the region g of FIG. 8).

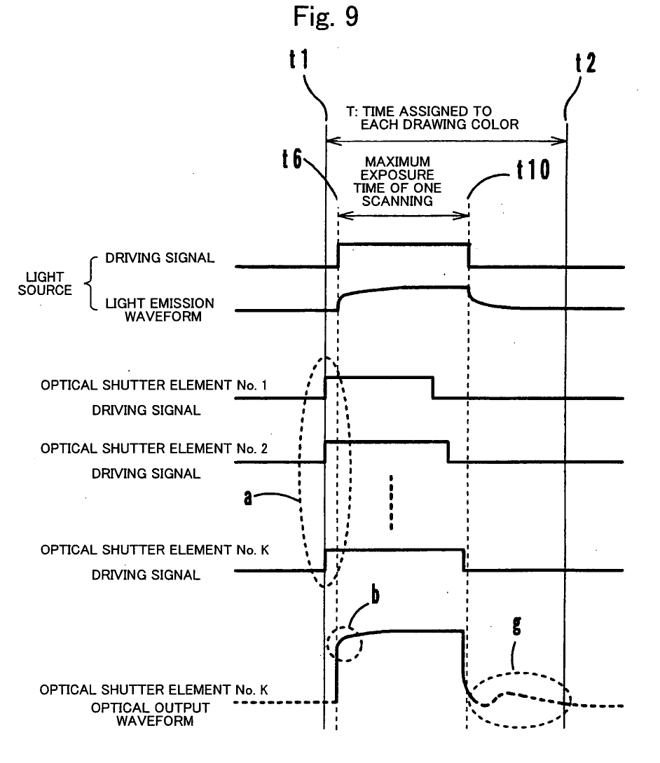

### Eighth Embodiment, See FIG. 9

As shown in FIG. 9, every scanning, the driving IC 13 turns on the optical shutter elements No. 1 to No. K simultaneously with the start timing t1 of the time T assigned to each drawing color, and turns them off at a timing corresponding to a predetermined gradation.

On the other hand, every scanning, the driving circuit 4 turns on the LED groups 1R, 1G and 1B at the timing t6 slightly delayed from the start timing t1, and turns them off at the timing t10 when the maximum exposure time of one scanning line (that is, the exposure time corresponding to the maximum gradation included in the image data of one scanning) ends.

In the eighth embodiment which is a combination of the first and the fifth embodiments, like in the first embodiment, the density difference caused when gray images of the same gradation are drawn is eliminated (see the region b of FIG. 9), and like in the fifth embodiment, the generation of the unevenness in streaks is eliminated (see the region g of FIG. 9).

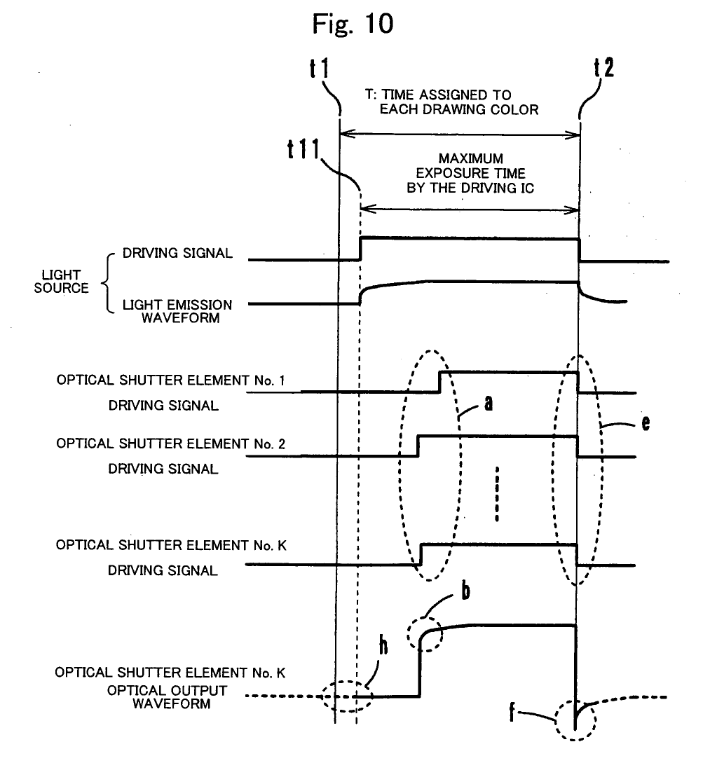

### Ninth Embodiment, See FIG. 10

As shown in FIG. 10, every scanning, the driving IC 13 turns off the optical shutter elements No. 1 to No. K simultaneously with the end timing t2 of the time T assigned to each drawing color. The timing at which the optical shutter elements are turned on (see the region a of FIG. 10) is a timing when an exposure time corresponding to a predetermined gradation is secured.

On the other hand, every scanning, the driving circuit 4 keeps the LED groups 1R, 1G and 1B on during the maximum exposure period by the driving IC 13, and turns them off synchronously with the turning-off of the optical shutter elements No. 1 to No. K. In this case, the timing at which the LED groups are turned on is t11.

In the ninth embodiment, like in the second embodiment, the influence of the noise caused in the image when the optical shutter elements are turned off is eliminated (see the region f of FIG. 10). In addition, as shown in the region h of FIG. 10, the generation of the unevenness in streaks due to the leakage light immediately before the optical shutter elements No. 1 to No. K are turned on (the period from the timing t1 to the timing t11) is eliminated.

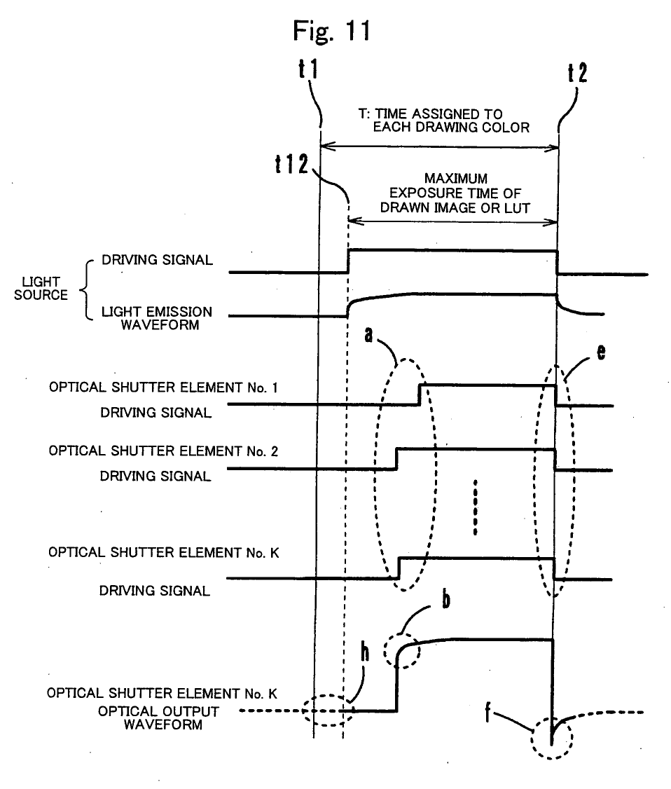

### Tenth Embodiment, See FIG. 11

As shown in FIG. 11, every scanning, the driving IC 13 turns off the optical shutter elements No. 1 to No. K simultaneously with the end timing t2 of the time T assigned to each drawing color. The timing at which the optical shutter elements are turned on is a timing when an exposure time corresponding to a predetermined gradation is secured (see the region a of FIG. 11).

On the other hand, every scanning, the driving circuit 4 keeps the LED groups 1R, 1G and 1B on during the exposure period corresponding to the maximum gradation included in the image data (that is, the maximum gradation of the drawn image or a look-up table (LUT) for gradation), and turns them off synchronously with the turning-off of the optical shutter elements No. 1 to No. K. In this case, the timing at which the LED groups are turned on is t12.

In the tenth embodiment, like in the second embodiment, the influence of the noise caused in the image when the optical shutter elements are turned off is eliminated (see the region f of FIG. 11). In addition, as shown in the region h of FIG. 11, the generation of the unevenness in streaks due to the leakage light immediately before the optical shutter elements No. 1 to No. K are turned on (the period from the timing t1 to the timing t12) is eliminated.

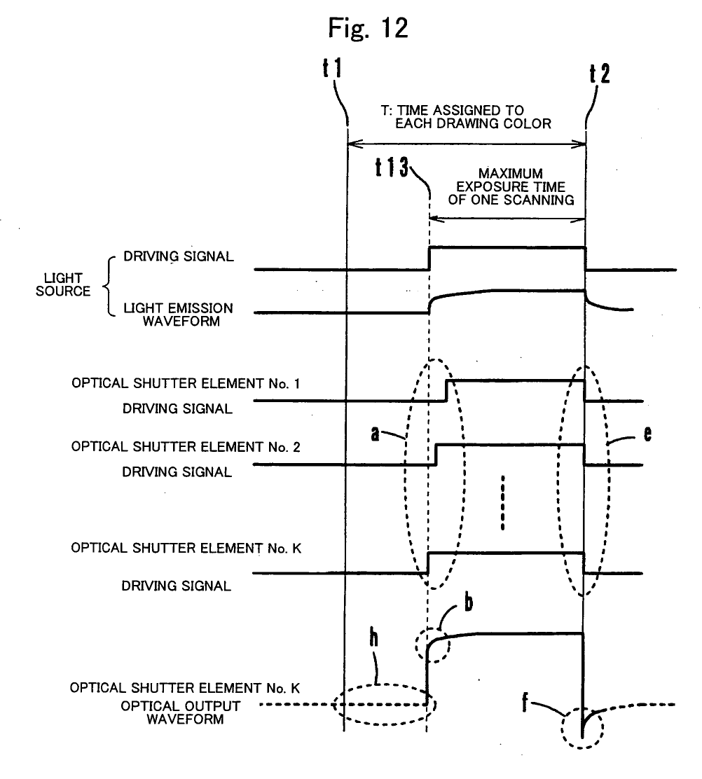

### Eleventh Embodiment, See FIG. 12)

As shown in FIG. 12, every scanning, the driving IC 13 turns off the optical shutter elements No. 1 to No. K simultaneously with the end timing t2 of the time T assigned to each drawing color. The timing at which the optical shutter elements are turned on is a timing when an exposure time corresponding to a predetermined gradation is secured (see the region a of FIG. 12).

On the other hand, every scanning, the driving circuit 4 keeps the LED groups 1R, 1G and 1B on during the maximum exposure period of one scanning line (that is, the exposure period corresponding to the maximum gradation included in the image data of one scanning), and turns them off synchronously with the turning-off of the optical shutter elements No. 1 to No. K. In this case, the timing at which the LED groups are turned on is t13.

In the eleventh embodiment, like in the second embodiment, the influence of the noise caused in the image when the optical shutter elements are turned off is eliminated (see the region f of FIG. 12). In addition, as shown in the region h of FIG. 12, the generation of the unevenness in streaks due to the leakage light immediately before the optical shutter elements No. 1 to No. K are turned on (the period from the timing t1 to the timing t13) is eliminated.

Although the present invention has been fully described by way of examples with reference to the accompanying drawings, it is to be noted that various change and modifications will be apparent to those skilled in the art. Therefore, unless otherwise such changes and modifications depart from the scope of the present invention, they should be construed as being including therein.

What is claimed is:

1. A solid scanning optical writing device comprising:
an optical shutter module in which a plurality of optical shutter elements having an electro-optical effect are disposed in a main scanning direction;
a light source that is capable of being controlled within a writing time assigned for drawing one pixel and emits light to the optical shutter elements;
a first driver for driving each of the optical shutter elements according to image data; and
a second driver for driving the light source,
wherein the first driver turns on the optical shutter elements, and
wherein the second driver turns on the light source after a lapse of a predetermined time from the turning-on of the optical shutter elements.

2. The solid scanning optical writing device according to claim 1, wherein the second driver turns on the light source after a lapse of a predetermined time from the turning-on of the optical shutter elements every scanning, and turns off the light source after a lapse of a maximum exposure time by the first driver.

3. The solid scanning optical writing device according to claim 1, wherein the second driver turns on the light source after a lapse of a predetermined time from the turning-on of the optical shutter elements every scanning, and turns off the light source after a lapse of an exposure time corresponding to a maximum gradation included in the image data.

4. The solid scanning optical writing device according to claim 1, wherein the second driver turns on the light source after a lapse of a predetermined time from the turning-on of the optical shutter elements every scanning, and turns off the light source after a lapse of an exposure time corresponding to a maximum gradation included in image data of one scanning.

5. The solid scanning optical writing device according to claim 1, wherein the light source is a light emitting diode.

6. A solid scanning optical writing device comprising:
an optical shutter module in which a plurality of optical shutter elements having an electro-optical effect are disposed in a main scanning direction;
a light source that is capable of being controlled within a writing time assigned for drawing one pixel and emits light to the optical shutter elements;
a first driver for driving each of the optical shutter elements according to image data; and
a second driver for driving the light source,
wherein the first driver turns off the optical shutter elements, and
wherein the second driver turns off the light source synchronously with the turning-off of the optical shutter elements.

7. The solid scanning optical writing device according to claim 6, wherein the second driver keeps the light source on during a maximum exposure period by the first driver every scanning, and turns off the light source synchronously with the turning-off of the optical shutter element.

8. The solid scanning optical writing device according to claim 6, wherein the second driver keeps the light source on during an exposure period corresponding to a maximum gradation included in the image data every scanning, and turns off the light source synchronously with the turning-off of the optical shutter elements.

9. The solid scanning optical writing device according to claim 6, wherein the second driver keeps the light source on during an exposure period corresponding to a maximum gradation included in the image data of one scanning, and turns off the light source synchronously with the turning-off of the optical shutter elements.

10. The solid scanning optical writing device according to claim 6, wherein the light source is a light emitting diode.

11. A solid scanning optical writing device comprising:
an optical shutter module in which a plurality of optical shutter elements having an electro-optical effect are disposed in a main scanning direction;
a light source that is capable of being controlled within a writing time assigned for drawing one pixel and emits light to the optical shutter elements;
a first driver for driving each of the optical shutter elements according to image data; and
a second driver for driving the light source,
wherein the second driver turns off the light source after a lapse of a maximum exposure time by the first driver.

12. The solid scanning optical writing device according to claim 11, wherein the light source is a light emitting diode.

13. A solid scanning optical writing device comprising:
an optical shutter module in which a plurality of optical shutter elements having an electro-optical effect are disposed in a main scanning direction;
a light source that is capable of being controlled within a writing time assigned for drawing one pixel and emits light to the optical shutter elements;
a first driver for driving each of the optical shutter elements according to image data; and
a second driver for driving the light source,
wherein the second driver turns off the light source after a lapse of an exposure time corresponding to a maximum gradation included in the image data.

14. The solid scanning optical writing device according to claim 13, wherein the light source is a light emitting diode.

15. A solid scanning optical writing device comprising:
an optical shutter module in which a plurality of optical shutter elements having an electro-optical effect are disposed in a main scanning direction;
a light source that is capable of being controlled within a writing time assigned for drawing one pixel and emits light to the optical shutter elements;
a first driver for driving each of the optical shutter elements according to image data; and
a second driver for driving the light source,
wherein the second driver turns off the light source after a lapse of an exposure time corresponding to a maximum gradation included in image data of one scanning.

16. The solid scanning optical writing device according to claim 15, wherein the light source is a light emitting diode.

17. A driving method of a solid scanning optical writing device including an optical shutter module in which a plurality of optical shutter elements having an electro-optical effect are disposed in a main scanning direction, a light source that is capable of being controlled within a writing time assigned for drawing one pixel and emits light to the optical shutter elements, a first driver for driving each of the optical shutter elements according to image data, and a second driver for driving the light source, the method comprising the steps of:
(a) turning on the optical shutter elements by the first driver, and
(b) turning on the light source by the second driver after a lapse of a predetermined time from the turning-on of the optical shutter elements,
wherein said steps of (a) and (b) are repeated every scanning.

18. A driving method of a solid scanning optical writing device including an optical shutter module in which a plurality of optical shutter elements having an electro-optical effect are disposed in a main scanning direction, a light source that is capable of being controlled within a writing time assigned for drawing one pixel and emits light to the optical shutter elements, a first driver for driving each of the optical shutter elements according to image data, and a second driver for driving the light source, the method comprising the steps of:
(a) turning on the optical shutter elements by the first driver, and
(b) turning off the light source synchronously with the turning-off of the optical shutter elements by the second driver,
wherein said steps of (a) and (b) are repeated every scanning.

19. A driving method of a solid scanning optical writing device including an optical shutter module in which a plurality of optical shutter elements having an electro-optical effect are disposed in a main scanning direction, a light source that is capable of being controlled within a writing time assigned for drawing one pixel and emits light to the optical shutter elements, a first driver for driving each of the optical shutter elements according to image data, and a second driver for driving the light source, the method comprising the steps of:
(a) turning on the optical shutter elements by the first driver, and
(b) turning off the light source by the second driver after a lapse of a maximum exposure time by the first driver,
wherein said steps of (a) and (b) are repeated every scanning.

20. A driving method of a solid scanning optical writing device including an optical shutter module in which a plurality of optical shutter elements having an electro-optical effect are disposed in a main scanning direction, a light source that is capable of being controlled within a writing time assigned for drawing one pixel and emits light to the optical shutter elements, a first driver for driving each of the optical shutter elements according to image data, and a second driver for driving the light source, the method comprising the steps of:
(a) turning on the optical shutter elements by the first driver, and
(b) turning off the light source by the second driver after a lapse of an exposure time corresponding to a maximum gradation included in the image data,
wherein said steps of (a) and (b) are repeated every scanning.

21. A driving method of a solid scanning optical writing device including an optical shutter module in which a plurality of optical shutter elements having an electro-optical effect are disposed in a main scanning direction, a light source that is capable of being controlled within a writing time assigned for drawing one pixel and emits light to the optical shutter elements, a first driver for driving each of the optical shutter elements according to image data, and a second driver for driving the light source, the method comprising the steps of:
(a) turning on the optical shutter elements by the first driver, and
(b) turning off the light source by the second driver after a lapse of an exposure time corresponding to a maximum gradation included in image data of one scanning,
wherein said steps of (a) and (b) are repeated every scanning.
